(19) United States
(12) Patent Application Publication
(10) Pub. No.: US 2026/0353414 A1
(43) Pub. Date: Nov. 5, 2026

(54) USER EQUIPMENT AND RESOURCE ALLOCATION METHOD IN SIDELINK COMMUNICATION

(71) Applicant: GUANGDONG OPPO MOBILE TELECOMMUNICATIONS CORP., LTD., Dongguan (CN)

(72) Inventor: Huei-Ming LIN, Taipei (TW)

(73) Assignee: GUANGDONG OPPO MOBILE TELECOMMUNICATIONS CORP., LTD., Dongguan (CN)

(21) Appl. No.: 19/654,197

(22) Filed: Apr. 21, 2026

Related U.S. Application Data
(63) Continuation of application No. PCT/CN2024/126491, filed on Oct. 22, 2024.
(60) Provisional application No. 63/545,649, filed on Oct. 25, 2023.

(51) Int. Cl. H04W 72/25

(52) U.S. Cl. CPC H04W 72/25

(57) ABSTRACT

A resource allocation method, user equipment and storage medium are provided. A resource allocation method in sidelink communication by a first user equipment (UE), includes performing resource allocation from one or more sidelink resource pools (RPs)/carriers based on a capability of a second UE, wherein the second UE is a sidelink data receiving UE.

### CROSS-REFERENCE TO RELATED APPLICATION

This application is a continuation of International Patent Application No. PCT/CN2024/126491 filed on Oct. 22, 2024, which claims priority from U.S. Patent Application No. 63/545,649 filed on Oct. 25, 2023. The disclosures of the applications are hereby incorporated by reference in their entirety.

### BACKGROUND OF DISCLOSURE

In the advancement of radio wireless transmission and reception directly between two devices, which is often known as device-to-device (D2D) communication, it was first developed by 3rd generation partnership project (3GPP) and introduced in Release 12 (officially specified as sidelink communication) and improved in Release 13 for Public Safety emergency usage such as mission critical communication to support mainly low data rate and voice type of connection. In 3GPP Release 14, 15 and 16, the sidelink technology was advanced to additionally support vehicle-to-everything (V2X) communication as part of global development of intelligent transportation system (ITS) to boost road safety and advanced/autonomous driving use cases. To further expand the support of sidelink technology to wider applications and devices with limited power supply/battery, the technology was further enhanced in Release 17 in the area of power saving and transceiver link reliability. In Release 18, 3GPP evolved the wireless technology and expanded its operation into unlicensed frequency spectrum for larger available bandwidth, faster data transfer rate and easier market adoption of D2D communication using sidelink without requiring any mobile cellular operator's involvement to allocate and configure a part of their expansive precious radio spectrum for data services that do not go throughput their mobile networks.

Therefore, there is a need for a user equipment (UE) and a resource allocation method in sidelink communication, which can solve issues in the prior art and other issues.

### SUMMARY

The present disclosure relates to the field of communication systems, and more particularly, to a user equipment (UE) and a resource allocation method in sidelink communication.

In a first aspect of the present disclosure, a resource allocation method in sidelink communication by a first user equipment (UE), including: performing resource allocation from one or more sidelink resource pools (RPs)/carriers based on a capability of a second UE, wherein the second UE is a sidelink data receiving UE.

In a second aspect of the present disclosure, a first user equipment (UE) includes a memory for storing instructions; and a processor configured to execute the instructions to control the first UE to perform an operation of: performing resource allocation from one or more sidelink resource pools (RPs)/carriers based on a capability of a second UE, wherein the second UE is a sidelink data receiving UE.

In a fourth aspect of the present disclosure, a non-transitory machine-readable storage medium has stored thereon instructions that, when executed by a processor of a first user equipment (UE), cause the processor to perform a method, the method comprising: performing resource allocation from one or more sidelink resource pools (RPs)/carriers based on a capability of a second UE, wherein the second UE is a sidelink data receiving UE.

### BRIEF DESCRIPTION OF DRAWINGS

In order to illustrate the embodiments of the present disclosure or related art more clearly, the following figures may be described in the embodiments are briefly introduced. It is obvious that the drawings are merely some embodiments of the present disclosure, a person having ordinary skill in this field can obtain other figures according to these figures without paying the premise.

FIG. 1 is a block diagram of user equipments (UEs) of communication in a communication network system according to an embodiment of the present disclosure.

FIG. 2 is a schematic diagram illustrating a user plane protocol stack according to an embodiment of the present disclosure.

FIG. 3 is a schematic diagram illustrating a control plane protocol stack according to an embodiment of the present disclosure.

FIG. 4 is a flowchart illustrating a resource allocation method in sidelink communication according to an embodiment of the present disclosure.

FIG. 5 is a schematic diagram illustrating a proposed resource selection method by a sidelink (SL) data transmitting UE in a multi-carrier SL operation to take into account of a radio frequency (RF) tuning/retuning time required for a sidelink data receiving UE to switch from one carrier to another carrier according to an embodiment of the present disclosure.

FIG. 6 is a schematic diagram illustrating a proposed resource selection method by a SL data transmitting UE in a multi-carrier SL operation to take into account of a transmission (TX) capability of a sidelink data receiving UE to transmit physical sidelink feedback channel (PSFCH) over multiple carriers according to an embodiment of the present disclosure.

FIG. 7 is a block diagram of a UE for wireless communication according to an embodiment of the present disclosure.

FIG. 8 is a block diagram of an example of a computing device according to an embodiment of the present disclosure.

FIG. 9 is a block diagram of a system for wireless communication according to an embodiment of the present disclosure.

### DETAILED DESCRIPTION OF EMBODIMENTS

Embodiments of the present disclosure are described in detail with the technical matters, structural features, achieved objects, and effects with reference to the accompanying drawings as follows. Specifically, the terminologies in the embodiments of the present disclosure are merely for describing the purpose of the certain embodiment, but not to limit the disclosure.

Device-to-device (D 2D) communication, first developed by 3GPP in Release 12 as sidelink communication, was improved in Release 13 for public safety and mission-critical communications. In Releases 14-16, it expanded to support vehicle-to-everything (V2X) for intelligent transportation systems. Release 17 focused on power saving and link reliability for devices with limited power. Release 18 further enhanced sidelink technology by enabling its use in unlicensed frequency bands, allowing faster data transfer and wider adoption without needing mobile operators' radio spectrum. For future releases of sidelink technology, one potential and promising technical feature is to support sidelink communication with simultaneous transmission (TX) and reception (RX) on multiple carriers and/or resource pools to further enhance the throughput data rate (via carrier aggregation, CA), in an assistance manner (one carrier assisting another carrier) and repeating data packets on multiple carriers to further enhance communication reliability (via packet duplication).

### Mode 2 Resource Allocation Mechanism in Sidelink

In the existing design of resource allocation mechanism for SL communication, a Mode 2 resource selection method relies on the SL data transmitting UE to perform autonomous selection of resources on its own from a pool of SL resources for transmission of data packets. In this resource allocation mode, the selection of transmission resources is not random at the start but based on a sensing and reservation strategy to avoid collision with other SL transmission UEs operating in the same resource pool. In this resource selection strategy, a SL data transmitting UE senses the channel for a period of a sensing window to decode and detect information about reservation of SL resources from other transmitting/surrounding UEs. Based on detected resource reservation information, the SL data transmitting UE excludes resources that are already reserved from selection to avoid transmission collision and selects a number of required resources from the remaining/available (non-reserved) ones randomly for its own transmission(s). During the transmissions using the selected resources, likewise, the SL data transmitting UE also sends out/broadcast its own resource reservation information in the resource pool using sidelink control information (SCI) messages so that other UEs may also avoid collision by not selecting the same or an overlap resource. In the existing resource indication and reservation signaling design, the time gap between two consecutive resources for reservation can be up to 31 slots apart within the same SL resource pool.

### Multi-Carrier SL Operation

During the early development of the NR sidelink technology in 3GPP, SL communication is supported on only a single carrier for both TX and RX in a single band. That is, it is not required for a SL UE to perform carrier switching (radio frequency, RF, tuning/retuning) in order to transmit to and receive data from other SL UEs. This assumption/support for SL operation has some drawbacks such as limited data rate support, not being able to support concurrent SL operation on more than one carrier unless an additional sidelink TX/RX module is implemented, resource selection and reception conflicts and etc. In order to mitigate this issue (to a certain extend), SL multi-carrier operation (termed SL carrier aggregation, SL-CA) based on a very limited set of functionalities was introduced in Release 18 for supporting V2X operation in the ITS band only with fragmented spectrum allocation, where SL-CA supports only Mode 2 resource allocation (without network intervention), per-carrier operation for both control, data and feedback reporting, and assumes a same sub-carrier spacing (SCS) among all aggregating SL carriers and no consideration of limited transmission and reception capability. With these restrictions, although it may be sufficient for V2X services, the SL-CA feature is not well suited for commercial network operation and Public Safety uses.

### Limited UE Capability in TX and/or RX

Besides electrical plug-in terminals, tablets and smartphones with a decent size of battery, there are currently a few other types of portable communication device with restricted size and constrained form factor that can only equipe with limited battery power to support applications with high processing demand such as glasses, watches, headphones, wrist bands and even bike helmets for vehicle-to-pedestrian (V2P) communication. For these power constrained devices, often due to its size and cost of running, practically they would be also restricted in terms of its wireless transmission (TX) and reception (RX) capabilities. For example, devices operating with 1TX/1RX antenna, lower bandwidth (BW) support, lower peak data rate and reduced active time in wireless transceiver operation to conserve power. In SL communication, the support for these devices with limited/reduced capabilities (SL RedCap UEs) has been very limited. In 3GPP Release 17, power saving features such as partial sensing and resource ransom selection are supported. However, devices with limited TX and RX capability are not well supported so far for the NR sidelink technology.

In some embodiments, in the present proposed new resource allocation methods for SL communication over multiple SL carriers/resource pools (RPs), a SL transmitter UE takes into account of RX and TX capabilities of sidelink data receiving UE during the resource selection to avoid/minimize miss-reception of SL data and dropping of physical sidelink feedback channel (PSFCH) transmission by the sidelink data receiving UE. Other benefits from using the proposed new resource allocation methods also include: Minimized latency of SL data delivery from avoiding miss-reception of physical sidelink control channel (PSCCH) and physical sidelink shared channel (PSSCH), and dropping of PSFCH transmission at the sidelink data receiving UE. As well as minimized channel congestion on the multiple SL carriers/RPs. Reduced retransmission of PSCCH/PSSCH across the SL RPs/carriers also minimizes collision probability/interference to other SL UEs operating over the same channels, thus, improving the overall performance of SL communication.

FIG. 1 illustrates that, in some embodiments, one or more user equipments (UEs) 10 (such as a first UE) and one or more user equipments (UEs) 20 (such as a second UE) of communication in a communication network system 30 according to an embodiment of the present disclosure are provided. The communication network system 30 includes one or more UEs 10 and one or more UE 20. The UE 10 may include a memory 12, a transceiver 13, and a processor 11 coupled to the memory 12 and the transceiver 13. The UE 20 may include a memory 22, a transceiver 23, and a processor 21 coupled to the memory 22 and the transceiver 23. The processor 11 or 21 may be configured to implement proposed functions, procedures and/or methods described in this description. Layers of radio interface protocol may be implemented in the processor 11 or 21. The memory 12 or 22 is operatively coupled with the processor 11 or 21 and stores a variety of information to operate the processor 11 or 21. The transceiver 13 or 23 is operatively coupled with the processor 11 or 21 and transmits and/or receives a radio signal.

The processor 11 or 21 may include application-specific integrated circuit (ASIC), other chipset, logic circuit and/or data processing device. The memory 12 or 22 may include read-only memory (ROM), random access memory (RAM), flash memory, memory card, storage medium and/or other storage device. The transceiver 13 or 23 may include baseband circuitry to process radio frequency signals. When the embodiments are implemented in software, the techniques described herein can be implemented with modules (e.g., procedures, functions, and so on) that perform the functions described herein. The modules can be stored in the memory 12 or 22 and executed by the processor 11 or 21. The memory 12 or 22 can be implemented within the processor 11 or 21 or external to the processor 11 or 21 in which case those can be communicatively coupled to the processor 11 or 21 via various means as is known in the art.

The communication between UEs relates to vehicle-to-everything (V2X) communication including vehicle-to-vehicle (V2V), vehicle-to-pedestrian (V2P), and vehicle-to-infrastructure/network (V2I/N) according to a sidelink technology developed under 3rd generation partnership project (3GPP) long term evolution (LTE) and new radio (NR) releases 17, 18 and beyond. UEs are communicated with each other directly via a sidelink interface such as a PC5 interface. Some embodiments of the present disclosure relate to sidelink communication technology in 3GPP NR releases 19 and beyond, for example providing cellular-vehicle to everything (C-V2X) communication.

In some embodiments, the UE 10 may be a sidelink packet transport block (TB) transmission UE (Tx-UE). The UE 20 may be a sidelink packet TB reception UE (Rx-UE) or a peer UE. The sidelink packet TB Rx-UE can be configured to send ACK/NACK feedback to the packet TB Tx-UE. The peer UE 20 is another UE communicating with the Tx-UE 10 in a same SL unicast or groupcast session.

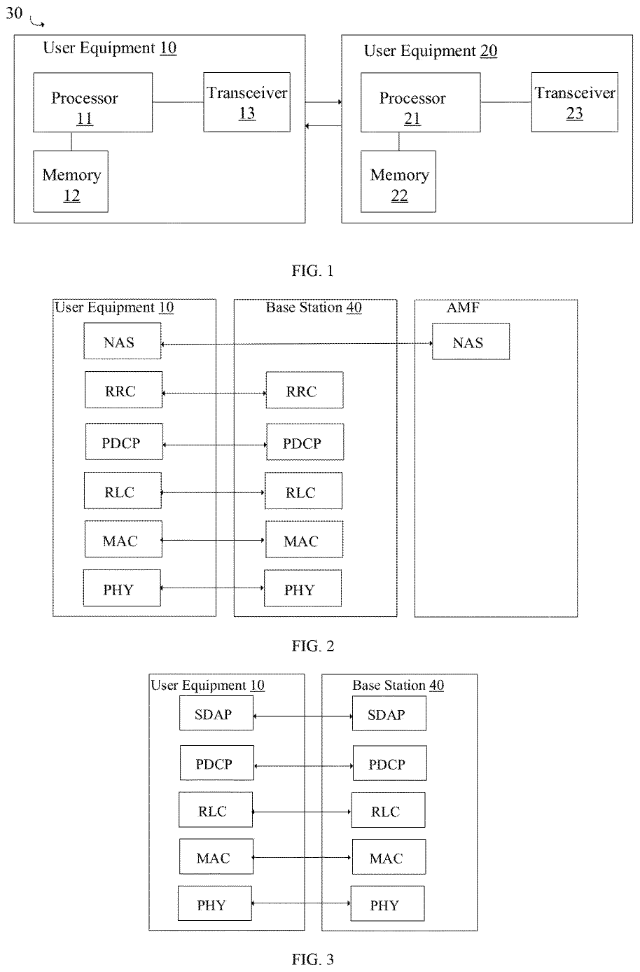

FIG. 2 illustrates an example user plane protocol stack according to an embodiment of the present disclosure. FIG. 2 illustrates that, in some embodiments, in the user plane protocol stack, where service data adaptation protocol (SDAP), packet data convergence protocol (PDCP), radio link control (RLC), and media access control (MAC) sublayers and physical (PHY) layer (also referred as first layer or layer 1 (L1) layer) may be terminated in a UE 10 and a base station 40 (such as gNB) on a network side. In an example, a PHY layer provides transport services to higher layers (e.g., MAC, RRC, etc.). In an example, services and functions of a MAC sublayer may comprise mapping between logical channels and transport channels, multiplexing/demultiplexing of MAC service data units (SDUs) belonging to one or different logical channels into/from transport blocks (TBs) delivered to/from the PHY layer, scheduling information reporting, error correction through hybrid automatic repeat request (HARQ) (e.g. one HARQ entity per carrier in case of carrier aggregation (CA)), priority handling between UEs by means of dynamic scheduling, priority handling between logical channels of one UE by means of logical channel prioritization, and/or padding. A MAC entity may support one or multiple numerologies and/or transmission timings. In an example, mapping restrictions in a logical channel prioritization may control which numerology and/or transmission timing a logical channel may use. In an example, an RLC sublayer may supports transparent mode (TM), unacknowledged mode (UM) and acknowledged mode (AM) transmission modes. The RLC configuration may be per logical channel with no dependency on numerologies and/or transmission time interval (TTI) durations. In an example, automatic repeat request (ARQ) may operate on any of the numerologies and/or TTI durations the logical channel is configured with. In an example, services and functions of the PDCP layer for the user plane may comprise sequence numbering, header compression, and decompression, transfer of user data, reordering and duplicate detection, PDCP PDU routing (e.g., in case of split bearers), retransmission of PDCP SDUs, ciphering, deciphering and integrity protection, PDCP SDU discard, PDCP re-establishment and data recovery for RLC AM, and/or duplication of PDCP PDUs. In an example, services and functions of SDAP may comprise mapping between a QoS flow and a data radio bearer. In an example, services and functions of SDAP may comprise mapping quality of service Indicator (QFI) in downlink (DL) and uplink (UL) packets. In an example, a protocol entity of SDAP may be configured for an individual PDU session.

FIG. 3 illustrates an example control plane protocol stack according to an embodiment of the present disclosure. FIG. 3 illustrates that, in some embodiments, in the control plane protocol stack where PDCP, RLC, and MAC layers and PHY layer may be terminated in a UE 10 and a base station 40 (such as gNB) on a network side and perform service and functions described above. In an example, radio resource control (RRC) used to control a radio resource between the UE and a base station (such as a gNB). In an example, RRC may be terminated in a UE and the gNB on a network side. In an example, services and functions of RRC may comprise broadcast of system information related to access stratum (AS) and non-access stratum (NAS), paging initiated by 5G core network (5GC) or radio access network (RAN), establishment, maintenance and release of an RRC connection between the UE and RAN, security functions including key management, establishment, configuration, maintenance and release of signaling radio bearers (SRBs) and data radio bearers (DRBs), mobility functions, QoS management functions, UE measurement reporting and control of the reporting, detection of and recovery from radio link failure, and/or non-access stratum (NAS) message transfer to/from NAS from/to a UE. In an example, NAS control protocol may be terminated in the UE and AMF on a network side and may perform functions such as authentication, mobility management between a UE and an access and mobility management function (AMF) for 3GPP access and non-3GPP access, and session management between a UE and a SMF for 3GPP access and non-3GPP access.

When a specific application is executed and a data communication service is required by the specific application in the UE, an application layer taking charge of executing the specific application provides the application-related information, that is, the application group/category/priority information/ID to the NAS layer. In this case, the application-related information may be pre-configured/defined in the UE. Alternatively, the application-related information is received from the network to be provided from the AS (RRC) layer to the application layer, and when the application layer starts the data communication service, the application layer requests the information provision to the AS (RRC) layer to receive the information.

In some embodiments, the processor 11 is configured to perform resource allocation from one or more sidelink RPs/carriers based on a capability of the UE 20 (such as the second UE), wherein the UE 20 is a sidelink data receiving UE. This can solve issues in the prior art and other issues and/or improve SL communication performance and reliability.

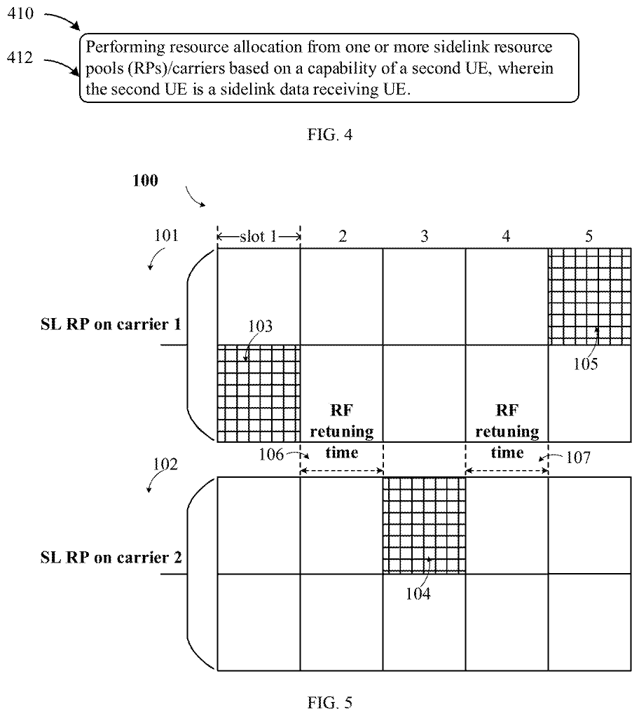

FIG. 4 illustrates a resource allocation method 410 in sidelink communication between user equipments (UEs) according to an embodiment of the present disclosure. In some embodiments, the resource allocation method 410 includes: an operation 412, performing resource allocation from one or more sidelink resource pools (RPs)/carriers based on a capability of a second UE, wherein the second UE is a sidelink data receiving UE. This can solve issues in the prior art and other issues and/or improve SL communication performance and reliability.

In some embodiments, performing the resource allocation from the one or more sidelink RPs/carriers based on the capability of the second UE includes excluding one or more candidate resources from the one or more sidelink RPs/carriers based on a reception capability of the second UE, wherein a number of remaining candidate resources within an overlapping slot over multiple sidelink RPs/carriers does not exceed the reception capability of the second UE or a number of radio frequency (RF) receiving chains supported by the second UE. In some embodiments, excluding the one or more candidate resources from the one or more sidelink RPs/carriers based on the reception capability of the second UE is performed in a physical layer of the first UE. In some embodiments, excluding the one or more candidate resources from the one or more sidelink RPs/carriers based on the reception capability of the second UE is performed in the physical layer of the first UE before reporting one or more subsets of candidate resources to a higher layer of the first UE. In some embodiments, performing the resource allocation from the one or more sidelink RPs/carriers based on the capability of the second UE includes avoiding selecting a number of sidelink resources in an overlapping slot from one or more sidelink RPs/carriers exceeding a reception capability of the second UE or a number of RF receiving chains supported by the second UE.

In some embodiments, avoiding selecting the number of sidelink resources in the overlapping slot from the one or more sidelink RPs/carriers exceeding the reception capability of the second UE or the number of the RF receiving chains supported by the second UE is performed in a medium access control (MAC) layer of the first UE. In some embodiments, avoiding selecting the number of sidelink resources in the overlapping slot from the one or more sidelink RPs/carriers exceeding the reception capability of the second UE or the number of the RF receiving chains supported by the second UE is performed in the MAC layer of the first UE after a physical layer of the first UE reports one or more subsets of candidate resources. In some embodiments, performing the resource allocation from the one or more sidelink RPs/carriers based on the capability of the second UE includes excluding one or more candidate resources from the one or more sidelink RPs/carriers based on a RF tuning/retuning time required at the second UE to switch a RF receiver circuitry/chain from one carrier to another carrier. In some embodiments, excluding the one or more candidate resources from the one or more sidelink RPs/carriers based on the RF tuning/retuning time required at the second UE is performed in a physical layer of the first UE. In some embodiments, excluding the one or more candidate resources from the one or more sidelink RPs/carriers based on the RF tuning/retuning time required at the second UE is performed in the physical layer of the first UE before reporting one or more subsets of candidate resources to a higher layer of the first UE. In some embodiments, performing the resource allocation from the one or more sidelink RPs/carriers based on the capability of the second UE includes performing a resource selection across one or more sidelink RPs/carriers with a minimum time gap between any two consecutive resources based on a RF tuning/retuning time required at the second UE to switch a RF receiver circuitry/chain of the second UE from one carrier to another carrier.

In some embodiments, performing the resource selection across one or more sidelink RPs/carriers with the minimum time gap between the any two consecutive resources based on the RF tuning/retuning time required at the second UE is performed in a MAC layer of the first UE. In some embodiments, performing the resource selection across one or more sidelink RPs/carriers with the minimum time gap between the any two consecutive resources based on the RF tuning/retuning time required at the second UE is performed in a MAC layer of the first UE after a physical layer of the first UE reports one or more subsets of candidate resources. In some embodiments, performing the resource allocation from the one or more sidelink RPs/carriers based on the capability of the second UE includes excluding one or more candidate resources from the one or more sidelink RPs/carriers based on a transmission capability of the second UE, wherein a number of sidelink carriers for sidelink hybrid automatic repeat request (HARQ) reporting on a physical sidelink feedback channel (PSFCH) does not exceed the transmission capability supported by the sidelink data receiving UE. In some embodiments, excluding the one or more candidate resources from the one or more sidelink RPs/carriers based on the transmission capability of the second UE is performed in a physical layer of the first UE. In some embodiments, excluding the one or more candidate resources from the one or more sidelink RPs/carriers based on the transmission capability of the second UE is performed in the physical layer of the first UE before reporting one or more subsets of candidate resources to a higher layer of the first UE.

In some embodiments, performing the resource allocation from the one or more sidelink RPs/carriers based on the capability of the second UE includes avoiding selecting a number of sidelink resources across one or more sidelink RPs/carriers, wherein the one or more sidelink RPs/carriers for the sidelink data receiving UE to transmit corresponding PSFCHs in a slot exceeding a transmission capability of the second UE or a number of transmission chains supported by the second UE. In some embodiments, avoiding selecting the number of sidelink resources across the one or more sidelink RPs/carriers is performed in a medium access control (MAC) layer of the first UE. In some embodiments, avoiding selecting the number of sidelink resources across the one or more sidelink RPs/carriers is performed in the MAC layer of the first UE after a physical layer of the first UE reports one or more subsets of candidate resources. In some embodiments, the capability of a second UE includes a reception capability of the second UE, a RF tuning/retuning time required at the second UE, and/or a transmission capability of the second UE, and the reception capability of the second UE, the RF tuning/retuning time required at the second UE, and/or the transmission capability of the second UE is configured in a sidelink multi-carrier operation. In some embodiments, a reception capability of the first UE, a RF tuning/retuning time required at the first UE, a transmission reception capability of the first UE, the reception capability of the second UE, the RF tuning/retuning time required at the second UE, and/or the transmission capability of the second UE are exchanged between the first UE and the second UE in a sidelink unicast communication using a PC5-radio resource control (RRC) signaling.

In some embodiments, in a sidelink broadcast communication or a sidelink groupcast communication, a reception capability of the first UE, a RF tuning/retuning time required at the first UE, and/or a transmission reception capability of the first UE is same as the reception capability of the second UE, the RF tuning/retuning time required at the second UE, and/or the transmission capability of the second UE, respectively. In some embodiments, in a sidelink broadcast communication or a sidelink groupcast communication, a reception capability of the first UE, a RF tuning/retuning time required at the first UE, a transmission reception capability of the first UE, the reception capability of the second UE, the RF tuning/retuning time required at the second UE, and/or the transmission capability of the second UE is based on a network configuration or a pre-configuration of a minimum value.

In some embodiments, the term “/” can be interpreted to indicate “and/or.” The term “configured” can refer to “pre-configured” and “network configured”. The term “preset”, “pre-defined” or “pre-defined rules” in the present disclosure may be achieved by pre-storing corresponding codes, tables, or other manners for indicating relevant information in devices (e.g., including a UE and a network device). The specific implementation is not limited in the present disclosure. For example, “preset” and “pre-defined” may refer to those defined in a protocol. It is also to be understood that in the disclosure, “protocol” may refer to a standard protocol in the field of communication, which may include, for example, an LTE protocol, NR protocol and relevant protocol applied in the future communication system, which is not limited in the present disclosure.

### EXAMPLES

In the existing operation of 3GPP new radio (NR) sidelink (SL) technology for direct device-to-device (D2D) wireless communication, one fundamental assumption is that a user equipment (UE) only operates in a single frequency carrier for both SL transmission (TX) and reception (RX) of synchronization signalling, control and feedback reporting information, and data messages. Therefore, in theory it is sufficient for a SL UE to be equipped with just 1TX and 1RX radio frequency (RF) chains for SL communication with other UEs in one carrier using earlier releases of SL technology. When UE operates in SL resource allocation Mode 2, as described previously, the UE autonomously selects resources from a SL resource pool (RP) in a SL frequency carrier based on sensing and reservation information obtained in that RP to avoid transmission collision with other UEs. Hence, the existing SL communication mechanism is a “per-carrier” based operation.

In the future releases of NR SL technology, when a SL UE needs to support and operate simultaneously on more than one carrier (e.g., for supporting different SL services, improving SL data throughput, reducing data delivery latency, enhancing SL communication reliability) and if this “per-carrier” operation continues to be adopted, SL communication for these services would operate independently on each carrier without any interaction. However, this “per-carrier” resource selection and independent operation in multi-carrier SL communication will create an issue for the data receiver UEs, when the UEs have limited reception and/or transmission capability.

In one scenario, assume a SL data transmitting UE and a sidelink data receiving UE both support/equipped with 2TX chains and 1 RX chain individually, if the transmitting TX UE selects and transmit data simultaneously on two SL carriers in one slot, the receiving RX UE would certainly not be able to receive (and subsequently decode data) on both SL carriers at the same time. As such, the receiving RX UE will miss-receive one of the two transmissions, and as such, either the transmitting TX UE will need to perform retransmission of the same data (adding latency to the data delivery, creating more traffic congestion on the channel and increasing collision probability/interference in the channel) or the data packet is simply not delivered (creating a bad user experience).

For the same assumption of 2TX and 1 RX chains at both the TX and RX UEs, in another scenario, even when a transmitting TX UE transmits data on two SL carriers (in different frequency bands) in different time slots, a certain radio frequency (RF) tuning/retuning time is needed for a receiving RX UE to switch/tuning/retuning its RF circuitry from one carrier to the other in order to receive data on both SL carriers. If the RF switching/tuning/retuning time is not taken into consideration by the data transmitting TX UE (e.g., back-to-back transmissions across the two SL carriers), it is certain the receiving RX UE would not be able to switch/tune/retune its RF circuitry fast enough to receive the transmission on the second SL carrier. Subsequently, resource re-selection for the second carrier would need to be triggered, adding further latency to the data packet delivery and increasing the probability of TX collision with other UEs due to no prior reservation to the newly selected resource.

In one scenario where the number of TX chains supported by the data transmitting TX UE is more than the number of TX chains supported by the data receiving RX UE, when data is transmitted over multiple SL RPs/carriers using all the TX chains supported by the data transmitting TX UE (either in the same slot or different slots) and their corresponding PSFCH feedback occasions fall in the same time slot across the multiple SL RPs/carriers, the data receiving RX UE would not be able to transmit all necessary SL-HARQ feedback reports on PSFCHs across all the multiple carriers. In this case, some SL-HARQ feedback reports on PSFCH would need to be dropped and the corresponding data should be retransmitted as such, adding latency to the data delivery and increasing traffic congestion on the channel.

Therefore, it is proposed in the present disclosure of new SL resource selection methods to perform autonomous selection of resources in SL Mode 2 for PSCCH/PSSCH transmissions using multiple SL resource pools (RPs)/carriers by excluding/avoiding selection of resources based on RX and/or TX capability of a receiving RX UE, so that the transmitted data across multiple SL RPs on multiple carriers would not be miss-received or the corresponding PSFCHs would not be dropped by the receiving RX UE.

In one example, in order to avoid/minimize any missed-reception at a sidelink data receiving UE of SL data transmitted simultaneously over multiple SL RPs/carriers by a SL data transmitting UE due to limited RX capability supported by the sidelink data receiving UE, in one of the present disclosed SL resource allocation methods, it is proposed for the SL data transmitting UE to exclude candidate resource(s) from one or more SL RPs/carriers based on the RX capability of the receiving RX UE, such that the number of remaining candidate resources within an overlapping slot over the multiple SL RPs/carriers does not exceed the RX capability/number of RF receiving chains supported by the sidelink data receiving UE, or avoid selecting a number of SL resources in an overlapping slot from the multiple SL RPs/carriers (e.g., candidate resource sets of the multiple SL RPs/carriers) exceeding the RX capability/number of RF receiving chains supported by the sidelink data receiving UE.

The exclusion of candidate resources could be performed in the physical (PHY) layer/Layer 1 (L1) of the SL data (i.e., PSCCH/PSSCH) transmitting UE, before reporting a subset(s) of candidate resources to a higher layer for the final resource selection. The above resource selection avoidance could be performed in the medium access control (MAC) layer of the SL data (i.e., PSCCH/PSSCH) transmitting UE after L1 reporting of a subset(s) of candidate resources. In another example, in order to avoid/minimize any missed-reception at a sidelink data receiving UE of SL data transmitted over multiple SL RPs/carriers by a SL data transmitting UE due to RF receiver chain switching time from one SL carrier to another SL carrier, in another one of the present disclosed SL resource allocation methods, it is proposed for the SL data transmitting UE to: exclude candidate resource(s) from one or multiple SL RPs/carriers based on a RF tuning/retuning time required for the sidelink data receiving UE to switching its RF receiver circuitry/chain from one carrier to another carrier for reception of all SL data from the SL data transmitting UE, or ensure a minimum time gap between any two consecutive resources that are selected across the multiple SL RPs/carriers to account for a RF tuning/retuning time required the sidelink data receiving UE to switching its RF receiver circuitry/chain from one carrier to another carrier for reception of SL data from the SL data transmitting UE.

The exclusion of candidate resources could be performed in the physical (PHY) layer/Layer 1 (L1) of the SL data (i.e., PSCCH/PSSCH) transmitting UE, before reporting a subset(s) of candidate resources to a higher layer for the final resource selection. The above criterion of a minimum time gap to account for the RF tuning/retuning time of a sidelink data receiving UE could be ensured during the resource selection in the MAC layer of the SL data (i.e., PSCCH/PSSCH) transmitting UE after L1 reporting of a subset(s) of candidate resources. In one more example, in order to avoid/minimized any missed-transmission or dropping of PSFCH transmission at a sidelink data receiving UE containing SL-HARQ feedback reports which correspond to SL data transmitted over multiple SL RPs/carriers by a SL data transmitting UE due to limited TX capability of the sidelink data receiving UE (i.e., the number of TX chains supported at the sidelink data receiving UE is less than the number of SL carriers needed to transmit multiple PSFCHs simultaneously in the same slot), in another one of the present disclosed SL resource allocation methods, it is proposed for the SL data transmitting UE to: exclude candidate resource(s) from one or more SL RPs/carriers based on the TX capability of the receiving RX UE, such that the number of SL carriers for SL-HARQ reporting on PSFCH does not exceed the TX capability supported by the sidelink data receiving UE, or avoid selecting resources across multiple SL RPs/carriers where the number of SL RPs/carriers for transmitting the corresponding PSFCHs in a slot (or within a PSFCH periodicity) exceeds the TX capability/number of TX chains supported by the data receiver UE.

The exclusion of candidate resources could be performed in the physical (PHY) layer/Layer 1 (L1) of the SL data (i.e., PSCCH/PSSCH) transmitting UE, before reporting a subset(s) of candidate resources to a higher layer for the final resource selection. The above resource selection avoidance could be performed in the MAC layer of the SL data (i.e., PSCCH/PSSCH) transmitting UE after L1 reporting of a subset(s) of candidate resources. In another embodiment of the present disclosure of resource allocation methods for SL communication using multiple SL resource pools/carriers, the RX/TX capability (e.g., number of SL RPs/carriers for simultaneous reception/transmission in a slot) and/or the required RF tuning/retuning time (e.g., a minimum time length for a receiver/transmitter chain to switch from one carrier to another carrier) of a SL UE could be (pre-)configured in a SL multi-carrier operation.

In one example, the RX/TX capability and/or a required RF tuning/retuning time of the two communicating UE in SL unicast could be exchanged between the two unicast UEs, e.g., using PC5-RRC signaling. In another example, in SL broadcast and groupcast, the RX/TX capability and/or a required RF tuning/retuning time of a receiving RX UE can be assumed to be the same as the transmitting TX UE, or the RX/TX capability and/or a required RF tuning/retuning time of a receiving RX UE is based on network configuration or pre-configuration of a minimum value (e.g., RX capability is 1 carrier, TX capability is 2 carriers, and RF tuning/retuning time is 1 slot).

In reference to Diagram 100 in FIG. 5, an exemplary illustration of one of the proposed resource allocation methods that takes into account by the SL data transmitting UE of a RF tuning/retuning time required for a sidelink data receiving UE to switch from one carrier to another carrier is shown when selecting SL resources for transmission in a multi-carrier SL operation. In the illustrated example, it is assumed firstly the multi-carrier SL operation (e.g., SL carrier aggregation) comprises a SL resource pool on carrier 1 (101) and a SL resource pool on carrier 2 (102) are configured/indicated for transmission by a first UE to deliver SL data messages. Secondly, it is assumed the RX capability of a sidelink data receiving UE is limited to only one RF receiver chain/circuitry for SL communication, and the required RF tuning/retuning time at the sidelink data receiving UE to switch from one carrier to another carrier (e.g., inter-band RF tuning/retuning/switching) is one slot length for the SCS of a configured SL carrier. That is, the RF tuning/retuning time is the minimum time gap required for a RF receiver circuitry to switch at the end of one slot on one carrier to the start of a slot on another carrier for SL reception. In order to ensure there is a sufficient RF returning time for the sidelink data receiving UE to perform carrier switching for receiving data (PSCCH/PSSCH) transmissions from a SL data transmitting UE, the SL data transmitting UE leaves a time gap equal to at least one RF tuning/retuning time length between two consecutive resources that are selected from different carriers during the resource selection process (e.g., in the MAC layer of the UE). As shown in Diagram 100 of FIG. 5, when one SL resource 103 is selected in the SL RP on carrier 1 (101) and a next SL resource 104 is selected in the SL RP on carrier 2 (102), a time gap of one RF tuning/retuning time 106 for the sidelink data receiving UE to perform carrier switching is ensured by the SL data transmitting UE between these two consecutively selected resources across the two carriers. That is, the SL data transmitting UE should not select any resources in slot 2 of the SL RP on carrier 2 (102) for SL data transmission targeting the same sidelink data receiving UE. Similarly, when the next/subsequent resource 105 after the selected resource 104 is selected from the SL RP on carrier 1 (101), a time gap of at least one RF tuning/retuning time 107 should be ensured again by the SL data transmitting UE for the sidelink data receiving UE to switch from carrier 2 (102) after having receive the data from the SL data transmitting UE in resource 104 to carrier 1 (101) for receiving the next data transmission in resource 105.

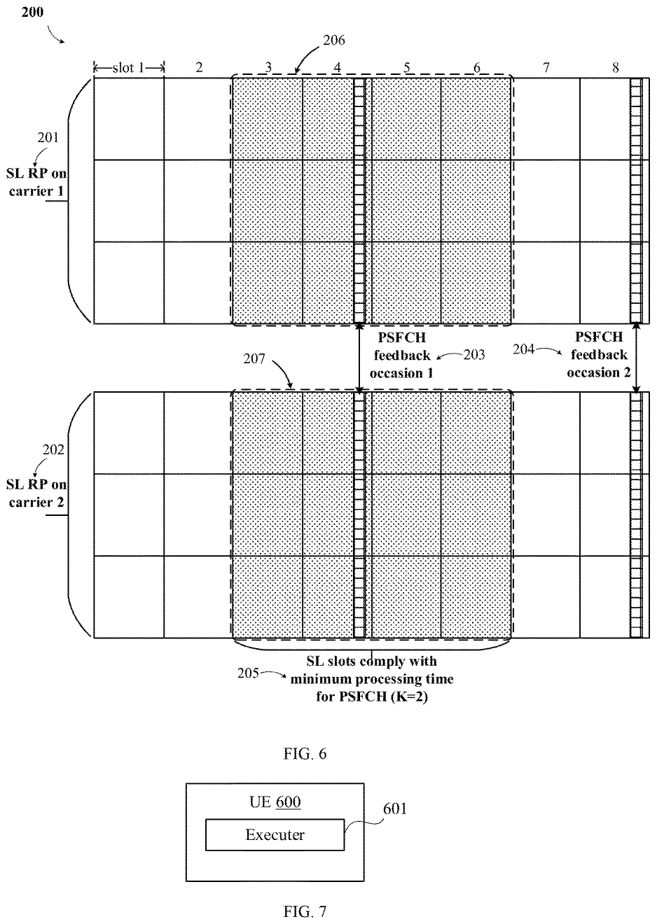

In reference to Diagram 200 in FIG. 6, an exemplary illustration of one of the proposed resource allocation methods that takes into account by the SL data transmitting UE of the TX capability of a sidelink data receiving UE for transmitting simultaneous PSFCHs across more than one SL carriers is shown when selecting SL resources for transmission in a multi-carrier SL operation. In the illustrated example, it is assumed firstly the multi-carrier SL operation (e.g., SL carrier aggregation) comprises a SL resource pool on carrier 1 (201) and a SL resource pool on carrier 2 (202) are configured/indicated for transmission by a first UE to deliver SL data messages. Secondly, it is assumed the TX capability (e.g., the number of carriers for simultaneous SL transmission) of the SL data transmitting UE and the receiving is 2 RF chains/circuitries and 1 RF chain/circuitry, respectively. Thirdly, the (pre-)configured PSFCH resource periodicity is 4 slots (i.e., meaning that a PSFCH feedback occasion occurs every 4 slots) and a minimum feedback time gap for preparing a corresponding PSFCH transmission after receiving a PSCCH/PSSCH is 2 slots (K=2) at the sidelink data receiving UE. Based on these assumptions, if PSFCH resources are firstly (pre-)configured in slot 4 on both carriers (201 and 202) representing PSFCH feedback occasion 1 (203), then the next PSFCH feedback occasion 2 (204) would be located in slot 8 on both carriers.

Correspondingly, the SL slots that comply with the minimum feedback processing time gap of K=2 to the PSFCH feedback occasion 2 (204) would be slots 3, 4, 5 and 6 (205). That is, if the sidelink data receiving UE receives any data transmitted within this said slots/time region (205) on either or both carriers (201 and 202) and SL-HARQ feedback reporting on PSFCH is required, the SL-HARQ feedback report would need to be transmitted in PSFCH feedback occasion 2 (204). As such, it is identified that SL resources within the dotted line 206 in Diagram 200 would correspond to the PSFCH feedback occasion 2 (204) on carrier 1, and SL resources within the dotted line 207 would correspond to the PSFCH feedback occasion 2 (204) on carrier 2. Since the TX capability of the sidelink data receiving UE is limited to only one TX chain/circuitry (i.e., not capable of performing simultaneous SL transmission on more than one carrier), which can be known by the SL data transmitting UE via (pre-)configuration, the SL data transmitting UE should select resources from only one carrier (201 or 202) for PSCCH/PSSCH transmission within the SL slot (205), otherwise, the sidelink data receiving UE would have to drop PSFCH transmission one of the said carriers in PSFCH feedback occasion 2 (204). That is, the resource selection within the slots of 205 by the SL data transmitting UE should be confined within only the SL resources of carrier 1 that correspond to PSFCH feedback occasion 2 (206) or confined within only the SL resources of carrier 2 that correspond to PSFCH feedback occasion 2 (207) to avoid PSFCH transmission dropping between the two carriers.

FIG. 7 illustrates a UE 600 for wireless communication according to an embodiment of the present disclosure. The UE 600 includes an executer 601. The executer 601 is configured to perform resource allocation from one or more sidelink RPs/carriers based on a capability of a second UE, wherein the second UE is a sidelink data receiving UE. This can solve issues in the prior art and other issues and/or improve SL communication performance and reliability.

In some embodiments, the executer 601 is configured to exclude the one or more candidate resources from the one or more sidelink RPs/carriers based on the reception capability of the second UE is performed in a physical layer of the first UE. In some embodiments, the executer 601 is configured to exclude the one or more candidate resources from the one or more sidelink RPs/carriers based on the reception capability of the second UE is performed in the physical layer of the first UE before reporting one or more subsets of candidate resources to a higher layer of the first UE. In some embodiments, the executer 601 is configured to avoid selecting a number of sidelink resources in an overlapping slot from one or more sidelink RPs/carriers exceeding a reception capability of the second UE or a number of RF receiving chains supported by the second UE. In some embodiments, the executer 601 is configured to avoid selecting the number of sidelink resources in the overlapping slot from the one or more sidelink RPs/carriers exceeding the reception capability of the second UE or the number of the RF receiving chains supported by the second UE is performed in a medium access control (MAC) layer of the first UE.

In some embodiments, the executer 601 is configured to avoid selecting the number of sidelink resources in the overlapping slot from the one or more sidelink RPs/carriers exceeding the reception capability of the second UE or the number of the RF receiving chains supported by the second UE is performed in the MAC layer of the first UE after a physical layer of the first UE reports one or more subsets of candidate resources. In some embodiments, the executer 601 is configured to exclude one or more candidate resources from the one or more sidelink RPs/carriers based on a RF tuning/retuning time required at the second UE to switch a RF receiver circuitry/chain from one carrier to another carrier. In some embodiments, the executer 601 is configured to exclude the one or more candidate resources from the one or more sidelink RPs/carriers based on the RF tuning/retuning time required at the second UE is performed in a physical layer of the first UE.

In some embodiments, the executer 601 is configured to exclude the one or more candidate resources from the one or more sidelink RPs/carriers based on the RF tuning/retuning time required at the second UE is performed in the physical layer of the first UE before reporting one or more subsets of candidate resources to a higher layer of the first UE. In some embodiments, the executer 601 is configured to perform a resource selection across one or more sidelink RPs/carriers with a minimum time gap between any two consecutive resources based on a RF tuning/retuning time required at the second UE to switch a RF receiver circuitry/chain of the second UE from one carrier to another carrier. In some embodiments, the executer 601 is configured to perform the resource selection across one or more sidelink RPs/carriers with the minimum time gap between the any two consecutive resources based on the RF tuning/retuning time required at the second UE is performed in a MAC layer of the first UE. In some embodiments, the executer 601 is configured to perform the resource selection across one or more sidelink RPs/carriers with the minimum time gap between the any two consecutive resources based on the RF tuning/retuning time required at the second UE is performed in a MAC layer of the first UE after a physical layer of the first UE reports one or more subsets of candidate resources.

In some embodiments, the executer 601 is configured to exclude one or more candidate resources from the one or more sidelink RPs/carriers based on a transmission capability of the second UE, wherein a number of sidelink carriers for sidelink hybrid automatic repeat request (HARQ) reporting on a physical sidelink feedback channel (PSFCH) does not exceed the transmission capability supported by the sidelink data receiving UE. In some embodiments, the executer 601 is configured to exclude the one or more candidate resources from the one or more sidelink RPs/carriers based on the transmission capability of the second UE is performed in a physical layer of the first UE. In some embodiments, the executer 601 is configured to exclude the one or more candidate resources from the one or more sidelink RPs/carriers based on the transmission capability of the second UE is performed in the physical layer of the first UE before reporting one or more subsets of candidate resources to a higher layer of the first UE. In some embodiments, the executer 601 is configured to avoid selecting a number of sidelink resources across one or more sidelink RPs/carriers, wherein the one or more sidelink RPs/carriers for the sidelink data receiving UE to transmit corresponding PSFCHs in a slot exceeding a transmission capability of the second UE or a number of transmission chains supported by the second UE.

In some embodiments, the executer 601 is configured to avoid selecting the number of sidelink resources across the one or more sidelink RPs/carriers is performed in a medium access control (MAC) layer of the first UE. In some embodiments, the executer 601 is configured to avoid selecting the number of sidelink resources across the one or more sidelink RPs/carriers is performed in the MAC layer of the first UE after a physical layer of the first UE reports one or more subsets of candidate resources. In some embodiments, the capability of a second UE includes a reception capability of the second UE, a RF tuning/retuning time required at the second UE, and/or a transmission capability of the second UE, and the reception capability of the second UE, the RF tuning/retuning time required at the second UE, and/or the transmission capability of the second UE is configured in a sidelink multi-carrier operation. In some embodiments, a reception capability of the first UE, a RF tuning/retuning time required at the first UE, a transmission reception capability of the first UE, the reception capability of the second UE, the RF tuning/retuning time required at the second UE, and/or the transmission capability of the second UE are exchanged between the first UE and the second UE in a sidelink unicast communication using a PC5-radio resource control (RRC) signaling.

In some embodiments, in a sidelink broadcast communication or a sidelink groupcast communication, a reception capability of the first UE, a RF tuning/retuning time required at the first UE, and/or a transmission reception capability of the first UE is same as the reception capability of the second UE, the RF tuning/retuning time required at the second UE, and/or the transmission capability of the second UE, respectively. In some embodiments, in a sidelink broadcast communication or a sidelink groupcast communication, a reception capability of the first UE, a RF tuning/retuning time required at the first UE, a transmission reception capability of the first UE, the reception capability of the second UE, the RF tuning/retuning time required at the second UE, and/or the transmission capability of the second UE is based on a network configuration or a pre-configuration of a minimum value.

In some embodiments, the term “/” can be interpreted to indicate “and/or.” The term “configured” can refer to “pre-configured” and “network configured”. The term “preset”, “pre-defined” or “pre-defined rules” in the present disclosure may be achieved by pre-storing corresponding codes, tables, or other manners for indicating relevant information in devices (e.g., including a UE and a network device). The specific implementation is not limited in the present disclosure. For example, “preset” and “pre-defined” may refer to those defined in a protocol. It is also to be understood that in the disclosure, “protocol” may refer to a standard protocol in the field of communication, which may include, for example, an LTE protocol, NR protocol and relevant protocol applied in the future communication system, which is not limited in the present disclosure.

In summary, in order to avoid/minimize missed-reception by a sidelink data receiving UE of data transmitted (e.g., simultaneously) in resource pools using multiple SL carriers, which would otherwise occur if the existing “per carrier” resource selection is performed by a SL data transmitting UE, it is proposed to adopt at least one of the following resource allocation methods by the SL data transmitting UE proposed in some embodiments of the present disclosure including performing resource allocation from one or more sidelink resource pools (RPs)/carriers based on a capability of a second UE, wherein the second UE is a sidelink data receiving UE. Method 1 involves the SL data transmitting UE managing resource selection to ensure the sidelink data receiving UE's RF chains can handle the number of selected resources. This is done either by excluding resources in Layer 1 (L1) or limiting selections in the MAC layer. Method 2 focuses on managing RF tuning time by either excluding resources in L1 based on required tuning times or ensuring a time gap between selected resources in the MAC layer to accommodate the RF switching of the sidelink data receiving UE. To minimize dropped PSFCH transmissions when using multiple SL carriers, a new resource allocation method is proposed. Method 3 allows the SL data transmitting UE to either exclude resources in Layer 1 (L1) based on the TX capability of the sidelink data receiving UE, ensuring the number of SL carriers does not exceed the UE's TX capacity, or in the MAC layer, avoid selecting resources that exceed the number of carriers the sidelink data receiving UE can handle within a PSFCH periodicity. In this resource allocation method for SL communication, the RX/TX capability and RF tuning/retuning time of a UE can be pre-configured for multi-carrier operations. For SL unicast, the two UEs can exchange this information via PC5-RRC signaling. In SL broadcast and groupcast, the sidelink data receiving UE's capability is either assumed to be the same as the SL data transmitting UE or based on a network configuration or pre-set minimum value.

Commercial interests for some embodiments are as follows. 1. Solving issues in the prior art and other issues. 2. Improving a sidelink (SL) communication performance. 3. Avoid/minimize miss-reception of SL data and dropping of physical sidelink feedback channel (PSFCH) transmission by the sidelink data receiving UE. 4. Some embodiments of the present disclosure are used by 5G-NR chipset vendors, V2X communication system development vendors, automakers including cars, trains, trucks, buses, bicycles, moto-bikes, helmets, and etc., drones (unmanned aerial vehicles), smartphone makers, smart watches, wireless earbuds, wireless headphones, communication devices, remote control vehicles, and robots for public safety use, AR/VR device maker for example gaming, conference/seminar, education purposes, smart home appliances including TV, stereo, speakers, lights, door bells, locks, cameras, conferencing headsets, and etc., smart factory and warehouse equipment including IIoT devices, robots, robotic arms, and simply just between production machines. In some embodiments, commercial interest for the disclosed invention and business importance includes lowering power consumption for wireless communication means longer operating time for the device and/or better user experience and product satisfaction from longer operating time between battery charging. Some embodiments of the present disclosure are a combination of “techniques/processes” that can be adopted in 3GPP specification to create an end product. Some embodiments of the present disclosure relate to mobile cellular communication technology in 3GPP NR Releases 17, 18, 19, and beyond for providing direct device-to-device (D2D) wireless communication services.

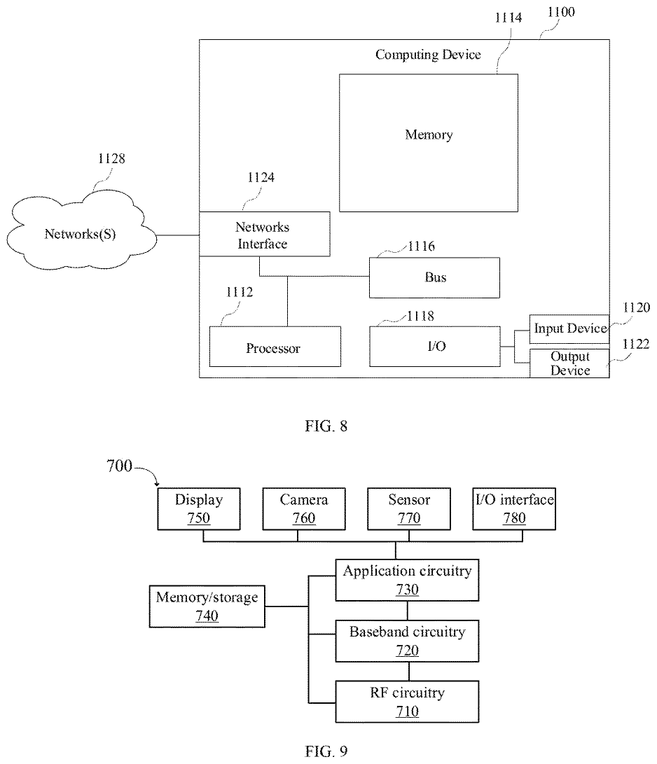

FIG. 8 is a block diagram of an example of a computing device according to an embodiment of the present disclosure. Any suitable computing device can be used for performing the operations described herein. For example, FIG. 8 illustrates an example of the computing device 1100 that can implement some embodiments in FIG. 1 to FIG. 7, using any suitably configured hardware and/or software. In some embodiments, the computing device 1100 can include a processor 1112 that is communicatively coupled to a memory 1114 and that executes computer-executable program code and/or accesses information stored in the memory 1114. The processor 1112 may include a microprocessor, an application-specific integrated circuit (“ASIC”), a state machine, or other processing device. The processor 1112 can include any of a number of processing devices, including one. Such a processor can include or may be in communication with a computer-readable medium storing instructions that, when executed by the processor 1112, cause the processor to perform the operations described herein.

The memory 1114 can include any suitable non-transitory computer-readable medium. The computer-readable medium can include any electronic, optical, magnetic, or other storage device capable of providing a processor with computer-readable instructions or other program code. Non-limiting examples of a computer-readable medium include a magnetic disk, a memory chip, a read-only memory (ROM), a random access memory (RAM), an application specific integrated circuit (ASIC), a configured processor, optical storage, magnetic tape or other magnetic storage, or any other medium from which a computer processor can read instructions. The instructions may include processor-specific instructions generated by a compiler and/or an interpreter from code written in any suitable computer-programming language, including, for example, C, C++, C #, visual basic, java, python, perl, javascript, and actionscript.

The computing device 1100 can also include a bus 1116. The bus 1116 can communicatively couple one or more components of the computing device 1100. The computing device 1100 can also include a number of external or internal devices such as input or output devices. For example, the computing device 1100 is illustrated with an input/output (“I/O”) interface 1118 that can receive input from one or more input devices 1120 or provide output to one or more output devices 1122. The one or more input devices 1120 and one or more output devices 1122 can be communicatively coupled to the I/O interface 1118. The communicative coupling can be implemented via any suitable manner (e.g., a connection via a printed circuit board, connection via a cable, communication via wireless transmissions, etc.). Non-limiting examples of input devices 1120 include a touch screen (e g., one or more cameras for imaging a touch area or pressure sensors for detecting pressure changes caused by a touch), a mouse, a keyboard, or any other device that can be used to generate input events in response to physical actions by a user of a computing device. Non-limiting examples of output devices 1122 include a liquid crystal display (LCD) screen, an external monitor, a speaker, or any other device that can be used to display or otherwise present outputs generated by a computing device.

The computing device 1100 can execute program code that configures the processor 1112 to perform one or more of the operations described above with respect to FIG. 1 to FIG. 7. The program code may be resident in the memory 1114 or any suitable computer-readable medium and may be executed by the processor 1112 or any other suitable processor.

The computing device 1100 can also include at least one network interface device 1124. The network interface device 1124 can include any device or group of devices suitable for establishing a wired or wireless data connection to one or more data networks 1128. Non limiting examples of the network interface device 1124 include an Ethernet network adapter, a modem, and/or the like. The computing device 1100 can transmit messages as electronic or optical signals via the network interface device 1124.

FIG. 9 is a block diagram of an example system 700 for wireless communication according to an embodiment of the present disclosure. Embodiments described herein may be implemented into the system using any suitably configured hardware and/or software. FIG. 9 illustrates the system 700 including a radio frequency (RF) circuitry 710, a baseband circuitry 720, an application circuitry 730, a memory/storage 740, a display 750, a camera 760, a sensor 770, and an input/output (I/O) interface 780, coupled with each other at least as illustrated.

The application circuitry 730 may include a circuitry such as, but not limited to, one or more single-core or multi-core processors. The processors may include any combination of general-purpose processors and dedicated processors, such as graphics processors, application processors. The processors may be coupled with the memory/storage and configured to execute instructions stored in the memory/storage to enable various applications and/or operating systems running on the system.

The baseband circuitry 720 may include circuitry such as, but not limited to, one or more single-core or multi-core processors. The processors may include a baseband processor. The baseband circuitry may handle various radio control functions that enables communication with one or more radio networks via the RF circuitry. The radio control functions may include, but are not limited to, signal modulation, encoding, decoding, radio frequency shifting, etc. In some embodiments, the baseband circuitry may provide for communication compatible with one or more radio technologies. For example, in some embodiments, the baseband circuitry may support communication with an evolved universal terrestrial radio access network (EUTRAN) and/or other wireless metropolitan area networks (WMAN), a wireless local area network (WLAN), a wireless personal area network (WPAN). Embodiments in which the baseband circuitry is configured to support radio communications of more than one wireless protocol may be referred to as multi-mode baseband circuitry.

In various embodiments, the baseband circuitry 720 may include circuitry to operate with signals that are not strictly considered as being in a baseband frequency. For example, in some embodiments, baseband circuitry may include circuitry to operate with signals having an intermediate frequency, which is between a baseband frequency and a radio frequency.

The RF circuitry 710 may enable communication with wireless networks using modulated electromagnetic radiation through a non-solid medium. In various embodiments, the RF circuitry may include switches, filters, amplifiers, etc. to facilitate the communication with the wireless network.

In various embodiments, the RF circuitry 710 may include circuitry to operate with signals that are not strictly considered as being in a radio frequency. For example, in some embodiments, RF circuitry may include circuitry to operate with signals having an intermediate frequency, which is between a baseband frequency and a radio frequency.

In various embodiments, the transmitter circuitry, control circuitry, or receiver circuitry discussed above with respect to the user equipment, eNB, or gNB may be embodied in whole or in part in one or more of the RF circuitry, the baseband circuitry, and/or the application circuitry. As used herein, “circuitry” may refer to, be part of, or include an application specific integrated circuit (ASIC), an electronic circuit, a processor (shared, dedicated, or group), and/or a memory (shared, dedicated, or group) that execute one or more software or firmware programs, a combinational logic circuit, and/or other suitable hardware components that provide the described functionality. In some embodiments, the electronic device circuitry may be implemented in, or functions associated with the circuitry may be implemented by, one or more software or firmware modules.

In some embodiments, some or all of the constituent components of the baseband circuitry, the application circuitry, and/or the memory/storage may be implemented together on a system on a chip (SOC). The memory/storage 740 may be used to load and store data and/or instructions, for example, for system. The memory/storage for one embodiment may include any combination of suitable volatile memory, such as dynamic random access memory (DRAM)), and/or non-volatile memory, such as flash memory.

In various embodiments, the I/O interface 780 may include one or more user interfaces designed to enable user interaction with the system and/or peripheral component interfaces designed to enable peripheral component interaction with the system. User interfaces may include, but are not limited to a physical keyboard or keypad, a touchpad, a speaker, a microphone, etc. Peripheral component interfaces may include, but are not limited to, a non-volatile memory port, a universal serial bus (USB) port, an audio jack, and a power supply interface.

In various embodiments, the sensor 770 may include one or more sensing devices to determine environmental conditions and/or location information related to the system. In some embodiments, the sensors may include, but are not limited to, a gyro sensor, an accelerometer, a proximity sensor, an ambient light sensor, and a positioning unit. The positioning unit may also be part of, or interact with, the baseband circuitry and/or RF circuitry to communicate with components of a positioning network, e.g., a global positioning system (GPS) satellite.

In various embodiments, the display 750 may include a display, such as a liquid crystal display and a touch screen display. In various embodiments, the system 700 may be a mobile computing device such as, but not limited to, a laptop computing device, a tablet computing device, a netbook, an ultrabook, a smartphone, a AR/VR glasses, etc. In various embodiments, system may have more or less components, and/or different architectures. Where appropriate, methods described herein may be implemented as a computer program. The computer program may be stored on a storage medium, such as a non-transitory storage medium.

A person having ordinary skill in the art understands that each of the units, algorithm, and steps described and disclosed in the embodiments of the present disclosure are realized using electronic hardware or combinations of software for computers and electronic hardware. Whether the functions run in hardware or software depends on the condition of application and design requirement for a technical plan.

A person having ordinary skill in the art can use different ways to realize the function for each specific application while such realizations cannot go beyond the scope of the present disclosure. It is understood by a person having ordinary skill in the art that he/she can refer to the working processes of the system, device, and unit in the above-mentioned embodiment since the working processes of the above-mentioned system, device, and unit are basically the same. For easy description and simplicity, these working processes may not be detailed.

It is understood that the disclosed system, device, and method in the embodiments of the present disclosure can be realized with other ways. The above-mentioned embodiments are exemplary only. The division of the units is merely based on logical functions while other divisions exist in realization. It is possible that a plurality of units or components are combined or integrated in another system. It is also possible that some characteristics are omitted or skipped. On the other hand, the displayed or discussed mutual coupling, direct coupling, or communicative coupling operate through some ports, devices, or units whether indirectly or communicatively by ways of electrical, mechanical, or other kinds of forms.

The units as separating components for explanation are or are not physically separated. The units for display are or are not physical units, that is, located in one place or distributed on a plurality of network units. Some or all of the units are used according to the purposes of the embodiments. Moreover, each of the functional units in each of the embodiments can be integrated in one processing unit, physically independent, or integrated in one processing unit with two or more than two units.

If the software function unit is realized and used and sold as a product, it can be stored in a readable storage medium in a computer. Based on this understanding, the technical plan proposed by the present disclosure can be essentially or partially realized as the form of a software product. Or, one part of the technical plan beneficial to the conventional technology can be realized as the form of a software product. The software product in the computer is stored in a storage medium, including a plurality of commands for a computational device (such as a personal computer, a server, or a network device) to run all or some of the steps disclosed by the embodiments of the present disclosure. The storage medium includes a USB disk, a mobile hard disk, a read-only memory (ROM), a random access memory (RAM), a floppy disk, or other kinds of media capable of storing program codes.

While the present disclosure has been described in connection with what is considered the most practical and preferred embodiments, it is understood that the present disclosure is not limited to the disclosed embodiments but is intended to cover various arrangements made without departing from the scope of the broadest interpretation of the appended claims.

1. A resource allocation method in sidelink communication by a first user equipment (UE), comprising:
performing resource allocation from one or more sidelink resource pools (RPs)/carriers based on a capability of a second UE, wherein the second UE is a sidelink data receiving UE.

2. The method of claim 1, wherein performing the resource allocation from the one or more sidelink RPs/carriers based on the capability of the second UE comprises:
excluding one or more candidate resources from the one or more sidelink RPs/carriers based on a reception capability of the second UE, wherein a number of remaining candidate resources within an overlapping slot over multiple sidelink RPs/carriers does not exceed the reception capability of the second UE or a number of radio frequency (RF) receiving chains supported by the second UE, wherein excluding the one or more candidate resources from the one or more sidelink RPs/carriers based on the reception capability of the second UE is performed in a physical layer of the first UE, wherein excluding the one or more candidate resources from the one or more sidelink RPs/carriers based on the reception capability of the second UE is performed in the physical layer of the first UE before reporting one or more subsets of candidate resources to a higher layer of the first UE.

3. The method of claim 1, wherein performing the resource allocation from the one or more sidelink RPs/carriers based on the capability of the second UE comprises:
avoiding selecting a number of sidelink resources in an overlapping slot from one or more sidelink RPs/carriers exceeding a reception capability of the second UE or a number of RF receiving chains supported by the second UE, wherein avoiding selecting the number of sidelink resources in the overlapping slot from the one or more sidelink RPs/carriers exceeding the reception capability of the second UE or the number of the RF receiving chains supported by the second UE is performed in a medium access control (MAC) layer of the first UE,
wherein avoiding selecting the number of sidelink resources in the overlapping slot from the one or more sidelink RPs/carriers exceeding the reception capability of the second UE or the number of the RF receiving chains supported by the second UE is performed in the MAC layer of the first UE after a physical layer of the first UE reports one or more subsets of candidate resources.

4. The method of claim 1, wherein performing the resource allocation from the one or more sidelink RPs/carriers based on the capability of the second UE comprises:
excluding one or more candidate resources from the one or more sidelink RPs/carriers based on a RF tuning/retuning time required at the second UE to switch a RF receiver circuitry/chain from one carrier to another carrier,
wherein excluding the one or more candidate resources from the one or more sidelink RPs/carriers based on the RF tuning/retuning time required at the second UE is performed in a physical layer of the first UE,
wherein excluding the one or more candidate resources from the one or more sidelink RPs/carriers based on the RF tuning/retuning time required at the second UE is performed in the physical layer of the first UE before reporting one or more subsets of candidate resources to a higher layer of the first UE.

5. The method of claim 1, wherein performing the resource allocation from the one or more sidelink RPs/carriers based on the capability of the second UE comprises:
performing a resource selection across one or more sidelink RPs/carriers with a minimum time gap between any two consecutive resources based on a RF tuning/retuning time required at the second UE to switch a RF receiver circuitry/chain of the second UE from one carrier to another carrier,
wherein performing the resource selection across one or more sidelink RPs/carriers with the minimum time gap between the any two consecutive resources based on the RF tuning/retuning time required at the second UE is performed in a MAC layer of the first UE,
wherein performing the resource selection across one or more sidelink RPs/carriers with the minimum time gap between the any two consecutive resources based on the RF tuning/retuning time required at the second UE is performed in a MAC layer of the first UE after a physical layer of the first UE reports one or more subsets of candidate resources.

6. The method of claim 1, wherein performing the resource allocation from the one or more sidelink RPs/carriers based on the capability of the second UE comprises:
excluding one or more candidate resources from the one or more sidelink RPs/carriers based on a transmission capability of the second UE, wherein a number of sidelink carriers for sidelink hybrid automatic repeat request (HARQ) reporting on a physical sidelink feedback channel (PSFCH) does not exceed the transmission capability supported by the sidelink data receiving UE,
wherein excluding the one or more candidate resources from the one or more sidelink RPs/carriers based on the transmission capability of the second UE is performed in a physical layer of the first UE,
wherein excluding the one or more candidate resources from the one or more sidelink RPs/carriers based on the transmission capability of the second UE is performed in the physical layer of the first UE before reporting one or more subsets of candidate resources to a higher layer of the first UE.

7. The method of claim 1, wherein performing the resource allocation from the one or more sidelink RPs/carriers based on the capability of the second UE comprises:
avoiding selecting a number of sidelink resources across one or more sidelink RPs/carriers, wherein the one or more sidelink RPs/carriers for the sidelink data receiving UE to transmit corresponding PSFCHs in a slot exceeding a transmission capability of the second UE or a number of transmission chains supported by the second UE,
wherein avoiding selecting the number of sidelink resources across the one or more sidelink RPs/carriers is performed in a medium access control (MAC) layer of the first UE,
wherein avoiding selecting the number of sidelink resources across the one or more sidelink RPs/carriers is performed in the MAC layer of the first UE after a physical layer of the first UE reports one or more subsets of candidate resources.

8. The method of claim 1, wherein the capability of a second UE comprises a reception capability of the second UE, a RF tuning/retuning time required at the second UE, and/or a transmission capability of the second UE, and the reception capability of the second UE, the RF tuning/retuning time required at the second UE, and/or the transmission capability of the second UE is configured in a sidelink multi-carrier operation,
wherein a reception capability of the first UE, a RF tuning/retuning time required at the first UE, a transmission reception capability of the first UE, the reception capability of the second UE, the RF tuning/retuning time required at the second UE, and/or the transmission capability of the second UE are exchanged between the first UE and the second UE in a sidelink unicast communication using a PC5-radio resource control (RRC) signaling,
wherein in a sidelink broadcast communication or a sidelink groupcast communication, a reception capability of the first UE, a RF tuning/retuning time required at the first UE, and/or a transmission reception capability of the first UE is same as the reception capability of the second UE, the RF tuning/retuning time required at the second UE, and/or the transmission capability of the second UE, respectively,
wherein in a sidelink broadcast communication or a sidelink groupcast communication, a reception capability of the first UE, a RF tuning/retuning time required at the first UE, a transmission reception capability of the first UE, the reception capability of the second UE, the RF tuning/retuning time required at the second UE, and/or the transmission capability of the second UE is based on a network configuration or a pre-configuration of a minimum value.

9. A first user equipment (UE), including:
a memory for storing instructions; and
a processor configured to execute the instructions to control the first UE to perform an operation of:
performing resource allocation from one or more sidelink resource pools (RPs)/carriers based on a capability of a second UE, wherein the second UE is a sidelink data receiving UE.

10. The UE of claim 9, wherein performing the resource allocation from the one or more sidelink RPs/carriers based on the capability of the second UE comprises:
excluding one or more candidate resources from the one or more sidelink RPs/carriers based on a reception capability of the second UE, wherein a number of remaining candidate resources within an overlapping slot over multiple sidelink RPs/carriers does not exceed the reception capability of the second UE or a number of radio frequency (RF) receiving chains supported by the second UE,
wherein excluding the one or more candidate resources from the one or more sidelink RPs/carriers based on the reception capability of the second UE is performed in a physical layer of the first UE, wherein excluding the one or more candidate resources from the one or more sidelink RPs/carriers based on the reception capability of the second UE is performed in the physical layer of the first UE before reporting one or more subsets of candidate resources to a higher layer of the first UE.

11. The UE of claim 9, wherein performing the resource allocation from the one or more sidelink RPs/carriers based on the capability of the second UE comprises:
avoiding selecting a number of sidelink resources in an overlapping slot from one or more sidelink RPs/carriers exceeding a reception capability of the second UE or a number of RF receiving chains supported by the second UE,
wherein avoiding selecting the number of sidelink resources in the overlapping slot from the one or more sidelink RPs/carriers exceeding the reception capability of the second UE or the number of the RF receiving chains supported by the second UE is performed in a medium access control (MAC) layer of the first UE,
wherein avoiding selecting the number of sidelink resources in the overlapping slot from the one or more sidelink RPs/carriers exceeding the reception capability of the second UE or the number of the RF receiving chains supported by the second UE is performed in the MAC layer of the first UE after a physical layer of the first UE reports one or more subsets of candidate resources.

12. The UE of claim 9, wherein performing the resource allocation from the one or more sidelink RPs/carriers based on the capability of the second UE comprises:
excluding one or more candidate resources from the one or more sidelink RPs/carriers based on a RF tuning/retuning time required at the second UE to switch a RF receiver circuitry/chain from one carrier to another carrier,
wherein excluding the one or more candidate resources from the one or more sidelink RPs/carriers based on the RF tuning/retuning time required at the second UE is performed in a physical layer of the first UE,
wherein excluding the one or more candidate resources from the one or more sidelink RPs/carriers based on the RF tuning/retuning time required at the second UE is performed in the physical layer of the first UE before reporting one or more subsets of candidate resources to a higher layer of the first UE.

13. The UE of claim 9, wherein performing the resource allocation from the one or more sidelink RPs/carriers based on the capability of the second UE comprises:
performing a resource selection across one or more sidelink RPs/carriers with a minimum time gap between any two consecutive resources based on a RF tuning/retuning time required at the second UE to switch a RF receiver circuitry/chain of the second UE from one carrier to another carrier,
wherein performing the resource selection across one or more sidelink RPs/carriers with the minimum time gap between the any two consecutive resources based on the RF tuning/retuning time required at the second UE is performed in a MAC layer of the first UE, wherein performing the resource selection across one or more sidelink RPs/carriers with the minimum time gap between the any two consecutive resources based on the RF tuning/retuning time required at the second UE is performed in a MAC layer of the first UE after a physical layer of the first UE reports one or more subsets of candidate resources.

14. The UE of claim 9, wherein performing the resource allocation from the one or more sidelink RPs/carriers based on the capability of the second UE comprises:
excluding one or more candidate resources from the one or more sidelink RPs/carriers based on a transmission capability of the second UE, wherein a number of sidelink carriers for sidelink hybrid automatic repeat request (HARQ) reporting on a physical sidelink feedback channel (PSFCH) does not exceed the transmission capability supported by the sidelink data receiving UE,
wherein excluding the one or more candidate resources from the one or more sidelink RPs/carriers based on the transmission capability of the second UE is performed in a physical layer of the first UE,
wherein excluding the one or more candidate resources from the one or more sidelink RPs/carriers based on the transmission capability of the second UE is performed in the physical layer of the first UE before reporting one or more subsets of candidate resources to a higher layer of the first UE.

15. The UE of claim 9, wherein performing the resource allocation from the one or more sidelink RPs/carriers based on the capability of the second UE comprises:
avoiding selecting a number of sidelink resources across one or more sidelink RPs/carriers, wherein the one or more sidelink RPs/carriers for the sidelink data receiving UE to transmit corresponding PSFCHs in a slot exceeding a transmission capability of the second UE or a number of transmission chains supported by the second UE,
wherein avoiding selecting the number of sidelink resources across the one or more sidelink RPs/carriers is performed in a medium access control (MAC) layer of the first UE,
wherein avoiding selecting the number of sidelink resources across the one or more sidelink RPs/carriers is performed in the MAC layer of the first UE after a physical layer of the first UE reports one or more subsets of candidate resources.

16. The UE of claim 9, wherein the capability of a second UE comprises a reception capability of the second UE, a RF tuning/retuning time required at the second UE, and/or a transmission capability of the second UE, and the reception capability of the second UE, the RF tuning/retuning time required at the second UE, and/or the transmission capability of the second UE is configured in a sidelink multi-carrier operation,
wherein a reception capability of the first UE, a RF tuning/retuning time required at the first UE, a transmission reception capability of the first UE, the reception capability of the second UE, the RF tuning/retuning time required at the second UE, and/or the transmission capability of the second UE are exchanged between the first UE and the second UE in a sidelink unicast communication using a PC5-radio resource control (RRC) signaling,
wherein in a sidelink broadcast communication or a sidelink groupcast communication, a reception capability of the first UE, a RF tuning/retuning time required at the first UE, and/or a transmission reception capability of the first UE is same as the reception capability of the second UE, the RF tuning/retuning time required at the second UE, and/or the transmission capability of the second UE, respectively,
wherein in a sidelink broadcast communication or a sidelink groupcast communication, a reception capability of the first UE, a RF tuning/retuning time required at the first UE, a transmission reception capability of the first UE, the reception capability of the second UE, the RF tuning/retuning time required at the second UE, and/or the transmission capability of the second UE is based on a network configuration or a pre-configuration of a minimum value.

17. A non-transitory machine-readable storage medium having stored thereon instructions that, when executed by a processor of a first user equipment (UE), cause the processor to perform a method, the method comprising: performing resource allocation from one or more sidelink resource pools (RPs)/carriers based on a capability of a second UE, wherein the second UE is a sidelink data receiving UE.

18. The non-transitory machine-readable storage medium of claim 17, wherein performing the resource allocation from the one or more sidelink RPs/carriers based on the capability of the second UE comprises:
excluding one or more candidate resources from the one or more sidelink RPs/carriers based on a reception capability of the second UE, wherein a number of remaining candidate resources within an overlapping slot over multiple sidelink RPs/carriers does not exceed the reception capability of the second UE or a number of radio frequency (RF) receiving chains supported by the second UE,
wherein excluding the one or more candidate resources from the one or more sidelink RPs/carriers based on the reception capability of the second UE is performed in a physical layer of the first UE, wherein excluding the one or more candidate resources from the one or more sidelink RPs/carriers based on the reception capability of the second UE is performed in the physical layer of the first UE before reporting one or more subsets of candidate resources to a higher layer of the first UE.

19. The non-transitory machine-readable storage medium of claim 17, wherein performing the resource allocation from the one or more sidelink RPs/carriers based on the capability of the second UE comprises:
avoiding selecting a number of sidelink resources in an overlapping slot from one or more sidelink RPs/carriers exceeding a reception capability of the second UE or a number of RF receiving chains supported by the second UE,
wherein avoiding selecting the number of sidelink resources in the overlapping slot from the one or more sidelink RPs/carriers exceeding the reception capability of the second UE or the number of the RF receiving chains supported by the second UE is performed in a medium access control (MAC) layer of the first UE,
wherein avoiding selecting the number of sidelink resources in the overlapping slot from the one or more sidelink RPs/carriers exceeding the reception capability of the second UE or the number of the RF receiving chains supported by the second UE is performed in the MAC layer of the first UE after a physical layer of the first UE reports one or more subsets of candidate resources.

20. The non-transitory machine-readable storage medium of claim 17, wherein performing the resource allocation from the one or more sidelink RPs/carriers based on the capability of the second UE comprises:
excluding one or more candidate resources from the one or more sidelink RPs/carriers based on a RF tuning/retuning time required at the second UE to switch a RF receiver circuitry/chain from one carrier to another carrier,
wherein excluding the one or more candidate resources from the one or more sidelink RPs/carriers based on the RF tuning/retuning time required at the second UE is performed in a physical layer of the first UE,
wherein excluding the one or more candidate resources from the one or more sidelink RPs/carriers based on the RF tuning/retuning time required at the second UE is performed in the physical layer of the first UE before reporting one or more subsets of candidate resources to a higher layer of the first UE.
